(19) United States
(12) Patent Application Publication
(10) Pub. No.: US 2025/0281001 A1
(43) Pub. Date: Sep. 11, 2025

(54) INGREDIENT STORAGE RECEPTACLE APPARATUS WITH ADJUSTABLE MEASURING AND DISPENSING

(71) Applicant: Amber Barrett, Menan, ID (US)

(72) Inventor: Amber Barrett, Menan, ID (US)

(21) Appl. No.: 19/070,739

(22) Filed: Mar. 5, 2025

Related U.S. Application Data
(60) Provisional application No. 63/562,957, filed on Mar. 8, 2024.
(60) Provisional application No. 63/651,179, filed on May 23, 2024.

(51) Int. Cl. A47J 47/01; A47J 47/04; A47J 47/08; B65D 83/06; G01F 11/24

(52) U.S. Cl. CPC A47J 47/01; A47J 47/04; A47J 47/08; B65D 83/06; G01F 11/24

(57) ABSTRACT

An ingredient storage receptacle apparatus includes a stand, a container, a housing, a roller positionable in the housing, a hopper, and a clip removably attachable to the hopper. The stand may be configured to receive the container, the housing, and the hopper. A user deposits ingredients into the hopper, where the ingredients proceed to troughs on the roller. The user may rotate the roller to deposit a predetermined, desired amount of ingredients into the container.

### CROSS-REFERENCE TO RELATED APPLICATIONS

This application claims the benefit of U.S. Provisional Application Ser. No. 63/562,957, filed on Mar. 8, 2024 and U.S. Provisional Application Ser. No. 63/651,179, filed on May 23, 2024, both of which are incorporated herein by reference.

### TECHNICAL FIELD

The present disclosure relates to an apparatus that stores and measures various dry ingredients and liquids. More particularly, the present disclosure relates to an apparatus that is configured to dispense various predetermined amounts of dry ingredients and liquids.

### BACKGROUND

Cooking has been an essential part of human life since the first humans walked the earth. Later on, humans began mixing food ingredients to achieve different results. These results were often recorded so as to allow other individuals to create the type of food recorded. Without these records, cooking becomes guess work, which may create varying outcomes. In order to re-create a recipe, it is important to have measuring devices to measure the ingredients precisely. Sometimes slight variations in ingredients can dramatically change the final product.

Due to the importance of measuring ingredients, there have been many types of measuring devices created. These devices vary in shape, size, configuration, etc. and can measure in cups, liters, ounces, tablespoons, teaspoons, and many other measurements. These measuring devices were also created to measure dry and liquid ingredients, with the devices usually being separated by dry and liquid ingredients. Even with the creation of the many measuring devices, there are still inherent shortcomings that stem from these devices. Some of these issues arise from an individual trying to find the correct size of measuring cup if there are too many and having both wet and dry measuring cups. Often it is messy and wasteful trying to measure the correct amount of ingredients, and because of that, it takes a lot of time to measure each ingredient in a recipe. Once the measuring is completed, or during measuring, each measuring device has to be rinsed and cleaned. In addition, it is easy to mismeasure which can affect the consistency and quality of recipes.

Accordingly, there is a need for an apparatus that removes the need for measuring cups, precisely measures both dry and liquid ingredients, decreases messes, and saves space. The present invention seeks to solve these and other problems.

### SUMMARY OF EXAMPLE EMBODIMENTS

In one embodiment, an ingredient storage receptacle apparatus with adjustable measuring and dispensing comprises a first housing positionable into a second housing. In some embodiments, the receptacle apparatus may comprise a single housing. The first and second housings may be generally rectangular in shape. The first and the second housings may be manufactured to be numerous sizes in height, length, and width. For example, a first size of both the first and second housings may be used for a dry ingredient, such as flour, while a second size, smaller than the first size, may be configured to receive a liquid, such as cooking oil. In some embodiments, there may be a first size, a second size, a third size, and a fourth size of the first and second housings. A front of the first housing may include an aperture that receives a measurement member. The aperture may be circumscribed by a ring that is substantially planar. The ring may assist in structurally stabilizing the outer edge of the aperture and act as a mating edge/surface and guide for the measurement member. The ring may be coupled to the front of the first housing via one or more fasteners.

The measurement member may include a shaft that is coupled to a plate at one end. A handle may be coupled to the plate, which may aid a user in turning/rotating the shaft. The measurement member may include a plurality of troughs with each of the troughs being configured to receive a predetermined amount of dry or liquid ingredients.

The second housing may comprise a cavity that receives the dry or liquid ingredients. On a base of the cavity there may be a channel between a first portion of the base and a second portion of the base. When the measurement member slides into the aperture, the measurement member may be positioned between the first portion of the base and the second portion of the base. The dry or liquid ingredients may be deposited at a bottom of the first housing through a deposit opening. The receptacle apparatus may receive a lid to seal the apparatus.

In one embodiment, an ingredient storage receptacle apparatus with adjustable measuring and dispensing may function with a computing system. The ingredient storage receptacle may comprise a housing with one or more partitioned compartments and a dispensing unit that is capable of dispensing numerous ranges of measurements. The apparatus may include a sensing device(s) in the compartments of the housing. The sensing devices may include weight/load/pressure sensors that can weigh quantity of ingredients in each compartment. The sensing devices may also include level sensors that can measure the level of a liquid or solid. Each of the compartments, or one or more of the compartments, may include sensing devices. The sensing devices may be connected to one or more transceivers that are capable of transmitting and receiving information. As contents, whether liquid or solid, in compartments drop below a predetermined low level, the sensing devices may communicate with the transceivers. These transceivers can then send messages to the computing system wherein the user is notified via the computing system that levels of contents in one or more of the compartments has reached a low level. The computing system may be configured to automatically communicate with various, pre-selected store applications or websites so that the low-level ingredients may be automatically ordered when the message is sent to the computing system from the sensing device.

### BRIEF DESCRIPTION OF THE DRAWINGS

FIG. 1 illustrates a perspective view of an ingredient storage receptacle apparatus with adjustable measuring and dispensing;

FIG. 2 illustrates a perspective view of an ingredient storage receptacle apparatus with adjustable measuring and dispensing;

FIG. 3 illustrates an exploded view of an ingredient storage receptacle apparatus with adjustable measuring and dispensing;

FIG. 4 illustrates a top plan view of an ingredient storage receptacle apparatus with adjustable measuring and dispensing;

FIG. 5 illustrates a diagram of a computing system for an ingredient storage receptacle apparatus with adjustable measuring and dispensing;

FIG. 6 illustrates a side perspective view of an ingredient storage receptacle apparatus with adjustable measuring and dispensing;

FIG. 7 illustrates a top perspective view of an insert of an ingredient storage receptacle apparatus with adjustable measuring and dispensing;

FIG. 8 illustrates a bottom perspective view of an ingredient storage receptacle apparatus with adjustable measuring and dispensing;

FIG. 9 illustrates a bottom perspective view of an insert of an ingredient storage receptacle apparatus with adjustable measuring and dispensing;

FIG. 10 illustrates a perspective view of an ingredient storage receptacle apparatus with adjustable measuring and dispensing;

FIG. 11 illustrates a side elevation view of an ingredient storage receptacle apparatus with adjustable measuring and dispensing;

FIG. 12 illustrates a side elevation view of an ingredient storage receptacle apparatus with adjustable measuring and dispensing;

FIG. 13 illustrates a side elevation view of an ingredient storage receptacle apparatus with adjustable measuring and dispensing;

FIG. 14 illustrates a perspective view of an ingredient storage receptacle apparatus with adjustable measuring and dispensing;

FIG. 15 illustrates a rear, side perspective view of an ingredient storage receptacle apparatus with adjustable measuring and dispensing;

FIG. 16 illustrates a perspective view of a roller of an ingredient storage receptacle apparatus with adjustable measuring and dispensing;

FIG. 17 illustrates a perspective view of a roller of an ingredient storage receptacle apparatus with adjustable measuring and dispensing;

FIG. 18 illustrates an exploded view of an ingredient storage receptacle apparatus with adjustable measuring and dispensing;

FIG. 19 illustrates an exploded view of an ingredient storage receptacle apparatus with adjustable measuring and dispensing; and

FIG. 20 illustrates an exploded view of an ingredient storage receptacle apparatus with adjustable measuring and dispensing.

### DETAILED DESCRIPTION OF EXAMPLE EMBODIMENTS

While embodiments of the present disclosure may be subject to various modifications and alternative forms, specific embodiments have been shown by way of example in the drawings and will be described in detail herein. However, the present disclosure is not intended to be limited to the particular features, forms, components, etc. disclosed. Rather, the present disclosure will cover all modifications, equivalents, and alternatives falling within the scope of the present disclosure.

Reference to the invention, the present disclosure, or the like are not intended to restrict or limit the invention, the present disclosure, or the like to exact features or steps of any one or more of the exemplary embodiments disclosed herein. References to “one embodiment,” “an embodiment,” “alternate embodiments,” “some embodiments,” and the like, may indicate that the embodiment(s) so described may include a particular feature, structure, or characteristic, but not every embodiment necessarily includes the particular feature, structure, or characteristic.

Any arrangements herein are meant to be illustrative and do not limit the invention's scope. Although specific terms are employed herein, they are used in a generic and descriptive sense only and not for purposes of limitation. Unless otherwise defined herein, such terms are intended to be given their ordinary meaning not inconsistent with that applicable in the relevant industry and without restriction to any specific embodiment hereinafter described. Certain terms are used herein, such as “comprising” and “including,” and similar terms are meant to be “open” and not “closed” terms.

It will be understood that the steps of any such processes or methods are not limited to being carried out in any particular sequence, arrangement, or with any particular graphics or interface. In fact, the steps of the disclosed processes or methods generally may be carried out in various, different sequences and arrangements while still being in the scope of the present invention.

Portions of the system may be implemented wholly in hardware, wholly in software or combining software and hardware implementation that may all generally be referred to herein as a “circuit,” “module,” “component,” or “system.” It will be understood that the computer program code for carrying out operations for features of the system on a smart device may be written in any programming language, which may include, but is not limited to, Objective-C, C++, C#, VB.NET, Java, Python, “C” programming language, Visual Basic, Perl, COBOL 2002, PHP, ABAP, Python, PHP, HTML, AJAX, or Ruby and Groovy. The program code may operate any portion of the system.

Portions of the system are illustrated in flowcharts and/or block diagrams. These flowcharts and/or block diagrams depict computer and mobile application program products according to embodiments of the system described herein. It will be understood that each block of the flowchart illustrations and/or block diagrams, and combinations of blocks in the flowchart illustrations and/or block diagrams, can be implemented by computer or mobile application program instructions.

As previously described, there is a need for an apparatus that removes the need for measuring cups, precisely measures both dry and liquid ingredients, decreases messes, and saves space. The present invention seeks to solve these and other problems.

Cooking has been around for many years and an important part of human life. To create simple or even complex dishes in contemporary times requires the combining of multiple ingredients. Some individuals use guess work to measure ingredients, which can often lead to recipes failing. Most individuals rely on some form of measuring device whether it be cups, spoons, bowls, etc. to correctly measure ingredients to put together a recipe. In fact, in order to re-create a recipe, it is important to have measuring devices to measure the ingredients precisely. Sometimes slight variations in ingredients can dramatically change the final product.

Even though there are many measuring devices on the market, these measuring devices have many downsides. Some of these downsides may include a user having too many measuring instruments, which leads to a lack of storage in a kitchen area and having to clean each used measuring instrument so as to reuse measuring instruments with other ingredients in a recipe. Furthermore, ingredients are usually stored in a storage bin that does not have a means of measuring the ingredients, other than bulk quantity. When an individual seeks to retrieve ingredients, the newest deposited ingredients are found at the top of the storage bin and used, so the older ingredients at the bottom of the storage bin often remain longer than they should, which can lead to stale and spoiled ingredients.

The ingredient storage receptacle described herein includes one or more housings, a measurement member that has a handle, and a lid. The measurement member may be configured to allow a user to deposit a predetermined, precise amount of dry or liquid ingredients. It will be understood that the receptacle allows for precise measurements and dispensing of ingredients.

In one embodiment, an ingredient storage receptacle apparatus with adjustable measuring and dispensing (hereinafter referred to as the “receptacle apparatus”) comprises a first housing positionable into a second housing (e.g., an insert). In some embodiments, the receptacle apparatus may comprise a single housing. The first and second housings may be generally rectangular in shape. Other shapes of the first and second housings may include a substantially square-shaped, cylindrical, or any other shape of housing. The first and second housings may be manufactured from a wooden material. However, while a wooden material is discussed, it will be understood that the first and second housings may be manufactured from a food grade plastic (e.g., high-density polyethylene, low-density polyethylene, and/or polypropylene), a metal (e.g., stainless steel and/or aluminum), any combination thereof, or any other food grade material known in the art. The housing may vary in construction and configuration based on the ingredients placed therein. For instance, some housings that are configured to receive liquids may be manufactured so as to prevent leaks and ensure longevity of the liquid ingredients.

The first and the second housings may be manufactured to be numerous sizes in height, length, and width. For example, a first size of both the first and second housings may be used for a dry ingredient, such as flour, while a second size, smaller than the first size, may be configured to receive a liquid, such as cooking oil. In some embodiments, there may be a first size, a second size, a third size, and a fourth size of the first and second housings. The first size may receive, for example, spices and be capable of depositing measurements that range from ⅛ tsp-1 Tbsp. The second size (e.g., a one-pound receptacle) may be larger than the first size and be capable of depositing measurements of ingredients that range from 1 Tbsp-1 Cup. The third size (e.g., a two-pound receptable) may be larger than the second size and be capable of depositing measurements of ingredients that range from 1 Tbsp-1 Cup. The fourth size (e.g., five-pound receptacle) may be larger than the third size and be capable of depositing measurements of ingredients that range from 1 Tbsp-2 cups. While only four sizes are discussed, it will be understood that more or less than four sizes may be manufactured and include other types of measurements, such as liters or ounces. In some embodiments, the various sizes of housings may be configured to be a single unit where all sizes may be removably attachable to each other and the single unit may be installed.

The various sizes of the housings may be color coded so as to allow a user to know the size of the housing based on color. For example, the third size may be blue while the fourth size is red. Other indicia may also be used, such as etched weights and measurements on an outer surface of the first housing.

A front of the first housing may include an aperture 108 that receives a measurement member. While the front of the first housing may have the aperture, it will be understood that any other side of the first housing may include the aperture. The aperture may be circumscribed by a ring that is substantially planar. The ring may assist in structurally stabilizing the outer edge of the aperture and act as a mating edge/surface and guide for the measurement member. The ring may be coupled to the front of the first housing via one or more fasteners. The fasteners may include screws; however, in some embodiments, the ring may be coupled to the front of the first housing via rivets, snap mechanisms, friction fittings, latches, etc. The ring, or another position on the first housing, may include markings that indicate the measurements that are desired to be dispensed when the measurement member is rotated. For example, the ring may include markings on how to rotate the measurement member to a ¼ Cup position, ½ Cup position, etc. to deposit the desired amount.

The measurement member may include a shaft that is coupled to a plate at one end. A handle may be coupled to the plate, which may aid a user in turning/rotating the shaft. A user may easily remove the shaft by grasping the handle and pulling the measurement member out of the first and second housings. The measurement member may include a plurality of troughs, with each of the troughs being configured to receive a predetermined amount of dry or liquid ingredients. For example, one of the troughs may be a size and depth that measures ¼ of a cup of ingredients while a second trough may be a size and depth that measures ½ of a cup of ingredients. While only three troughs are shown, it will be appreciated that more or less than three troughs may be on the shaft. There may be a plurality of walls that separate and define each of the plurality of troughs on the shaft.

The second housing may comprise a cavity that receives the dry or liquid ingredients. On a base of the cavity there may be a channel between a first portion of the base and a second portion of the base. When the measurement member slides into the aperture, the measurement member may be positioned between the first portion of the base and the second portion of the base. The dry or liquid ingredients may be deposited at a bottom of the first housing through a deposit opening, which may be passed to or funneled to a separate storage container so as to transfer the ingredients to a cooking station. In some embodiments, the dry or liquid ingredients may be deposited on a front, a back, or either side of the first housing. In some embodiments, dispensing may be through funnels, nozzles, hoses, or any other dispensing device.

The receptacle apparatus may receive a lid to seal the apparatus. The lid may hingedly coupled to an upper surface of the housings or may rest on the upper surface of the housing. The lid may also include latches, or any other securing mechanism, to secure the lid. The lid may also include a handle to assist a user in opening the receptacle apparatus. The receptacle apparatus may be configured to rest on a counter top or may be configured to mount on a wall, for example, via brackets.

To use the receptacle apparatus and deposit ingredients, a user may dispense the dry or liquid ingredients by turning the handle. The user may turn the handle to a marker for a predetermined measurement and rotate the measurement member back to a dispense position so as to release the ingredients.

The receptacle apparatus allows a user to increase storage space by omitting measuring cups, spoons, etc. Typically, when a user is retrieving an ingredient, the newest ingredient at a top of the container is measured and retrieved to be used in cooking, leaving the oldest ingredients in the lower portion of storage containers. When these containers become low on ingredients, new ingredients are placed on top of the remaining, old ingredients, meaning many of the oldest ingredients may not be used. Even individual spice containers on spice racks, are dispensed out of the top thereof and have to be measured. It will further be appreciated that the receptacle apparatus removes the need for measuring cups; it allows precise measuring, leading to more accurate and consistent cooking/baking; and it decreases cooking time and prevents messes.

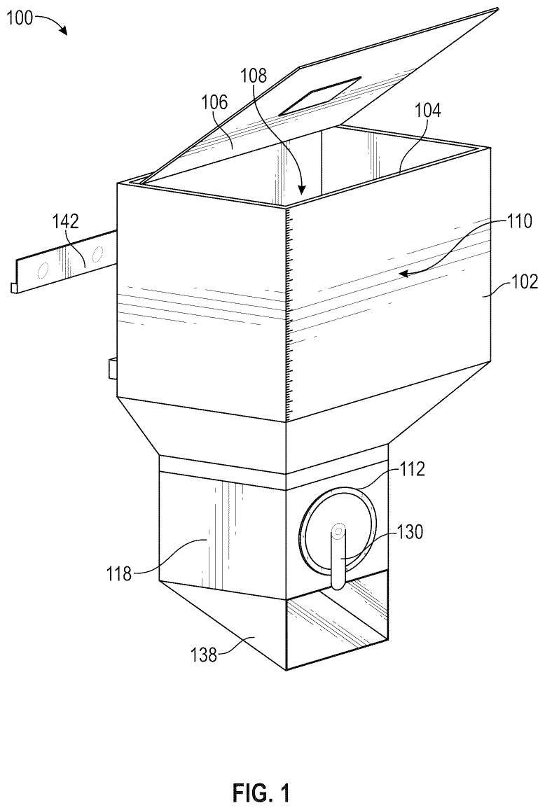

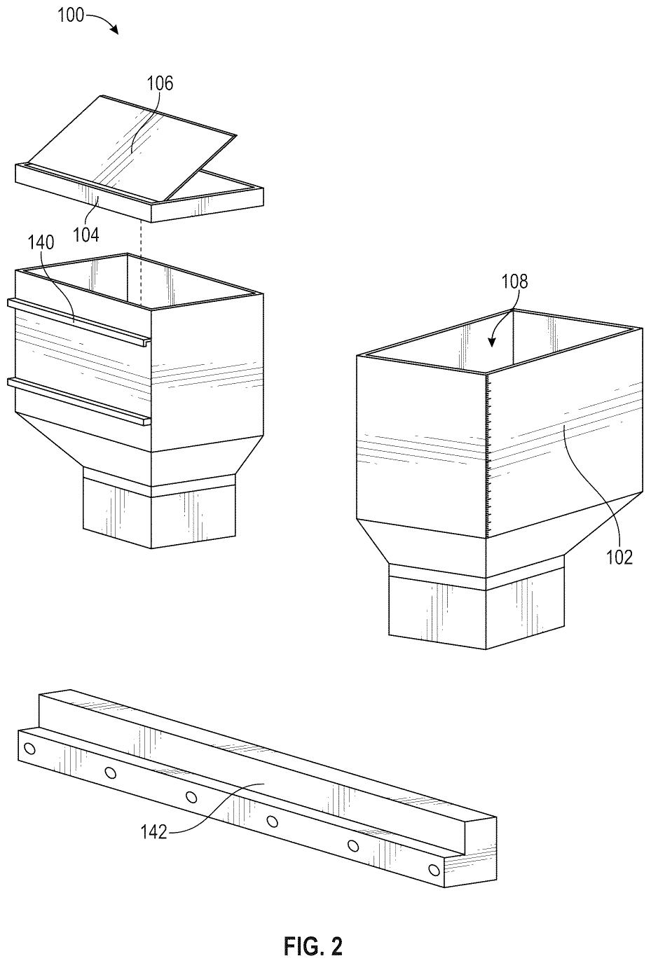

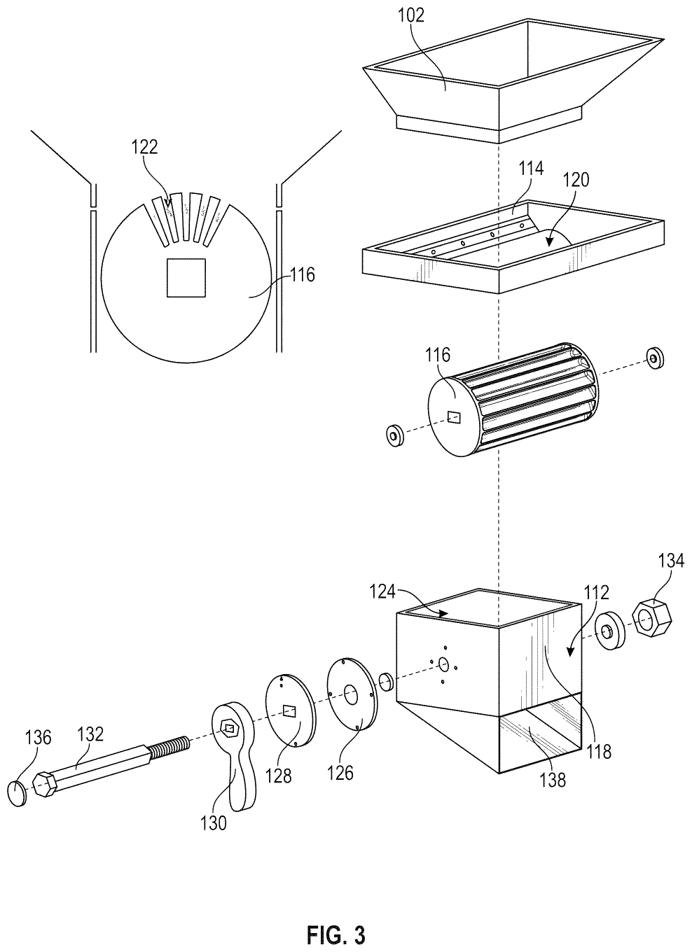

As shown in FIGS. 1-3, in one embodiment, an ingredient storage receptacle apparatus 100 with adjustable measuring and dispensing (hereinafter referred to as the “receptacle apparatus”) comprises a housing 102. The housing 102 may be generally rectangular in shape. Other shapes of the housing may include a substantially square-shaped, cylindrical, or any other shape of housing 102. The housing 102 may be manufactured from a wooden material. However, while a wooden material is discussed, it will be understood that the housing 102 may be manufactured from a food grade plastic (e.g., high-density polyethylene, low-density polyethylene, and/or polypropylene), a metal (e.g., stainless steel and/or aluminum), any combination thereof, or any other food grade material known in the art. The housing 102 may vary in construction and configuration based on the ingredients placed therein.

The housing 102 may be manufactured to be numerous sizes in height, length, and width. In some embodiments, there may be a first size, a second size, a third size, and a fourth size of the housing. The first size may receive, for example, spices and be capable of depositing measurements that range from ⅛ tsp-1 Tbsp. The second size (e.g., a one-pound receptacle) may be larger than the first size and be capable of depositing measurements of ingredients that range from 1 Tbsp-1 Cup. The third size (e.g., a two-pound receptable) may be larger than the second size and be capable of depositing measurements of ingredients that range from 1 Tbsp-1 Cup. The fourth size (e.g., five-pound receptacle) may be larger than the third size and be capable of depositing measurements of ingredients that range from 1 Tbsp-2 cups. While only four sizes are discussed, it will be understood that more or less than four sizes may be manufactured and include other types of measurements, such as liters or ounces. In some embodiments, the various sizes of housings may be configured to be a single unit where all sizes may be removably attachable to each other and the single unit may be installed. The various sizes of the housings may be color coded so as to allow a user to know the size of the housing based on color. The housings may also be transparent or opaque.

A top housing member 104 of the housing 102 may include a lid 106. The lid 106 may be hingedly coupled to the top housing member 104. The top housing member 104 may circumscribe an upper edge of the housing 102. In particular, the top housing member 104 may include a lip that wraps around the upper edge of the housing 102. The top housing member 104 may be removed from the housing 102. In some embodiments, the lid 106 may be sealed via latches, friction fitting, or any other type of securement mechanism. When the lid 106 is lifted a user may access a cavity 108 of the housing 102. A front 110 of the housing 102 may include measurement markings so as to provide an indication as to the quantity of ingredients in the housing 102.

A lower portion of the housing 102 may be generally funnel-shaped so as to channel and dispense dry or liquid ingredients. The lower portion of the housing 102 may receive a dispensing unit 112. The dispensing unit 112 may be removably attachable to the lower portion of the housing 102. The dispensing unit 112 may include a first member 114, a shaft member 116, and a second, housing member 118. The first member may be coupled to the lower portion of the housing 102. The shaft member 116 may couple to the second, housing member 118 and interact with the first member 114. That is, the shaft member 116 may, when in a resting and secured position, be placed in a channel 120 (with scraping arms) created by the first member 114. The shaft member 116 may include a plurality of troughs 122, with each of the troughs 122 being configured to receive a predetermined amount of dry or liquid ingredients. For example, one of the troughs 122 may be a size and depth that measures ¼ of a cup of ingredients while a second trough may be a size and depth that measures ½ of a cup of ingredients. While five troughs are shown, it will be appreciated that more or less than five troughs may be on the shaft member 116. The plurality of troughs 122 on the shaft 116 may wrap around a portion of the shaft member 116, such as half of the circumference or all of the circumference. The shaft member 116 may be positioned in a second cavity 124 in the second member 118 and be coupled thereto.

A side of the second member 118 may have an aperture. The side of the second member 118 may be configured to receive a first plate 126 that contacts the second member 118, a second plate 128, and a handle 130. The first plate 126, the second plate 128, and the handle 130 may each have an aperture. The first plate 126 may include markings that indicate the measurements that are desired to be dispensed when the shaft member 116 is rotated. To secure the first plate 126, the second plate 128, and the handle 130, a fastener 132 (e.g., a square bolt) may be placed through the aperture on the handle 130, the aperture on the second plate 128, and the aperture on the first plate 126. The fastener 132 may continue to pass through the aperture on the side of the second member 118, through an aperture on the shaft member 116, through an aperture on a second side of the second member 118, and be secured with a second fastener 134 (e.g., a washer and nut). An end cap 136 may be placed over an end of the fastener 132 at the handle 130. A lower portion of the second member may include an angled chute 138 to dispense ingredients.

A back of the housing 102 may include one or more bracket lips 140 that may be positioned on brackets 142 coupled to a wall. The brackets 142 allow users to position the receptacle 100 on any wall.

Similar to receptacle 100, a user may dispense the dry or liquid ingredients by turning the handle 130. The user may turn the handle 130 to a marker for a predetermined measurement and rotate the shaft member 116 back to a dispense position so as to release the ingredients.

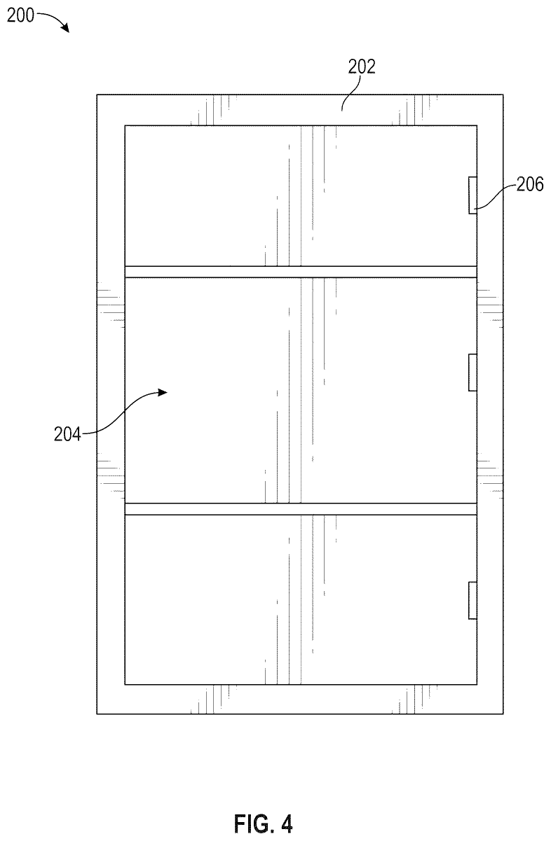

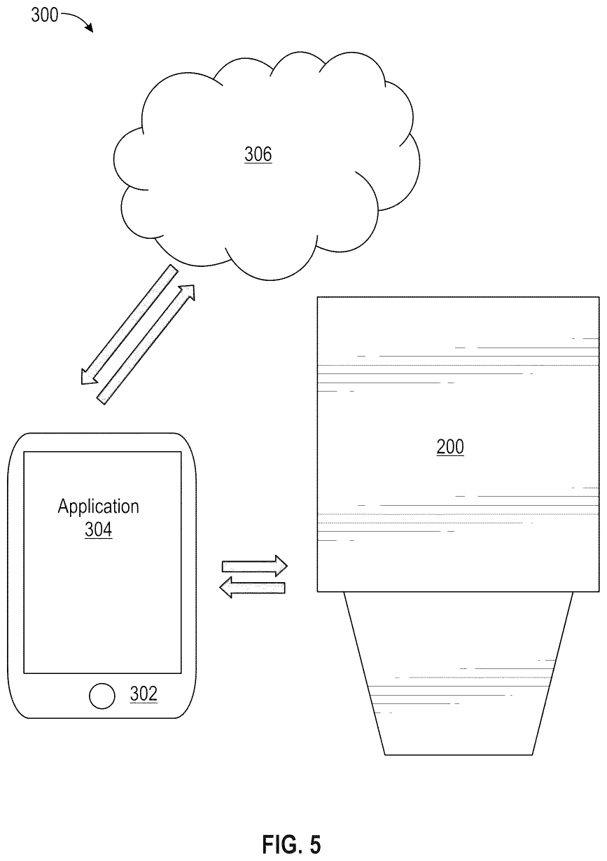

As shown in FIGS. 4-5, in one embodiment, an ingredient storage receptacle apparatus with adjustable measuring and dispensing 200 (hereinafter “apparatus”) may function with a computing system 300. It will be understood that any of the ingredient storage receptacle apparatuses may function with the computing system 300. The ingredient storage receptacle 200 may comprise a housing 202 with one or more partitioned compartments 204 and a dispensing unit (not shown) that is capable of dispensing numerous ranges of measurements. Each compartment 204 may store different types of ingredients or may store the same ingredients. Each compartment 204 may be the same size, difference sizes, or a combination of the two. The apparatus 200 may comprise a first size of housing, a second size of housing, etc. The first size may be larger than the second size. For example, the first size may be configured for commercial use while the second size is configured for personal use. The apparatus 200 may include some or all of the features of either apparatus 100 or any other apparatus disclosed herein. Furthermore, the apparatus 200 may include a sensing device(s) 206 in the compartments of the housing. The sensing devices 206 may include weight/load/pressure sensors that can weigh quantity of ingredients in each compartment 204. In some embodiments, the sensing devices 206 may also include level sensors that can measure the level of a liquid or solid (e.g., granular material). The level sensors may include radar, ultrasonic, acoustic, etc. Each of the compartments 204, or one or more of the compartments, may include sensing devices 206. The sensing devices 206 may be connected to one or more transceivers that are capable of transmitting and receiving information. The sensing devices 206 may be connected to the transceivers either wirelessly or via a wire. In some embodiments, the sensing devices 206 may include a transceiver or transmitter. As contents, whether liquid or solid, in compartments drop below a predetermined low level, the sensing devices may communicate with the transceivers. These transceivers can then send messages to the computing system 300 wherein the user is notified via the computing system 300 that levels of contents in one or more of the compartments 304 has reached a low level. It will be appreciated that the predetermined low level may be adjusted in each compartment 204 independent of other compartments to a level desired by a user.

As shown in FIG. 5, the apparatus 200 may communicate with the computing system 300. The computing system 300 may include a smart device 302 and an application 304 (e.g., mobile or software) on the smart device 302. The application may interact with a cloud platform 306 with a remote server via, for example, WI-FI. The smart device 302 may be a smart phone, tablet, or any other computing device, such as a computer. The smart device 302 may comprise a display (e.g., a touch screen display), a processor, memory, and storage. The memory may be RAM, such as LPDDR, LPDDR2, LPDDR3, LPDDR4, or any other variation of RAM. The memory may also comprise ROM, such as EPROM or Flash EEPROM.

The smart device 302 via the application 304 may communicate with the cloud platform 306, which in turn, communicates with the smart device 302. The cloud platform 306 may comprise stored data and other features necessary to operate the application 304. For example, the cloud platform 306 may store data on time periods (i.e., depletion periods for certain ingredients) regarding the length of time for compartments to reach predetermined low levels after being filled to capacity. This stored data may be stored on a server on the cloud or a remote server. When the predetermined low level is sensed by the sensing device, the transceiver may send the message or alert to the smart device 302 that communicates with the application 304. At that point, the user may order additional ingredients that were located in the signaling compartment. The application 304 may allow a user to select the types of ingredients so that the low-level signal sent from the signaling compartment may flag which ingredient needs to be added to the compartment 204. The smart device 302, through the application 304, may be configured to automatically communicate with various, pre-selected store applications or websites so that the low ingredients may be automatically ordered when the signal is sent to the smart device 302 from the sensing device 206. It will be appreciated that the apparatus 300 with the computing system 300 allows a business owner to have an automated ingredient inventory, allows oldest ingredients to be used first, allows exact measurements of ingredients for employees and at home users, and increases organization of ingredients at a restaurant or home.

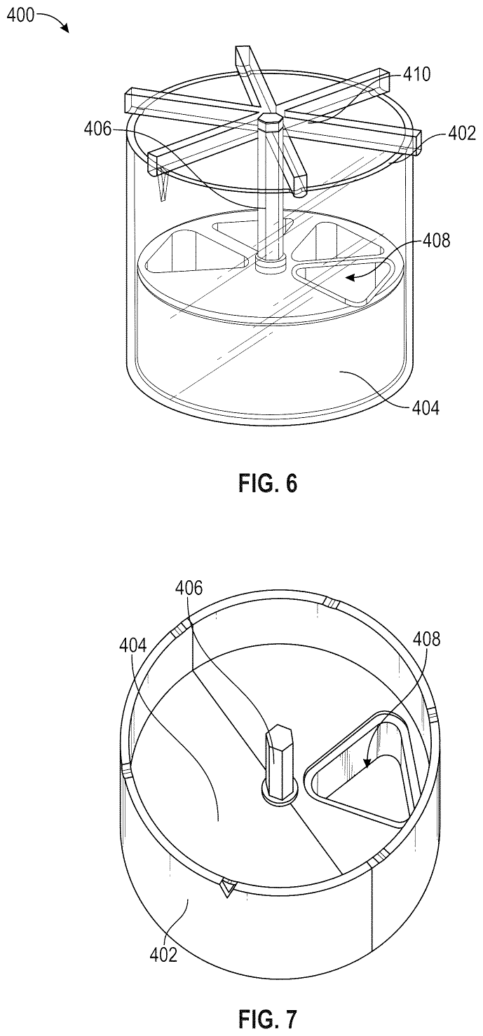

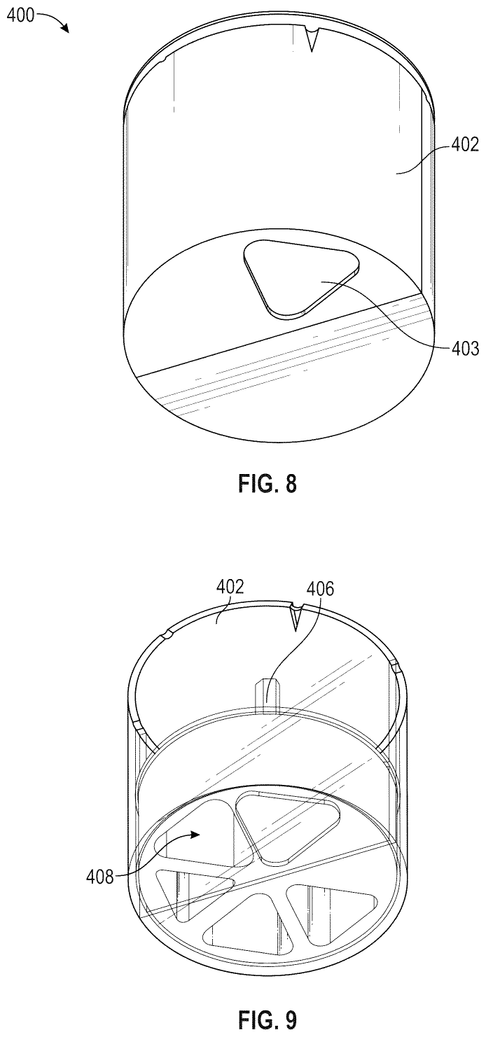

As shown in FIGS. 6-9, in one embodiment, an ingredient storage receptacle apparatus 400 with adjustable measuring and dispensing (hereinafter referred to as the “receptacle apparatus”) comprises a housing 402 and an insert 404 that is position able in the housing 402. The housing 402 may be generally cylindrically shaped. Other shapes of the housing 402 may include a substantially square-shaped or any other shape of housing. The housing 402 may be a wooden material, a food grade plastic (e.g., high-density polyethylene, low-density polyethylene, and/or polypropylene), a metal (e.g., stainless steel and/or aluminum), any combination thereof, or any other food grade material known in the art.

The housing 402 may include a door 403 that covers an aperture on the bottom of the housing 402. A lid may also be affixed to an upper portion of the housing 402. The housing 402 may vary in construction and configuration based on the ingredients placed therein. For instance, some housings that are configured to receive liquids may be manufactured so as to prevent leaks and ensure longevity of the liquid ingredients. The housing 402 may be manufactured to be numerous sizes in height, length, and width. For example, a first size of the housing 402 may be used for a dry ingredient, such as flour, while a second size, smaller than the first size, may be configured to receive a liquid, such as cooking oil. In some embodiments, there may be a first size, a second size, a third size, and a fourth size of the housing. The first size may receive, for example, spices and be capable of depositing measurements that range from ⅛ tsp-1 Tbsp. The second size (e.g., a one-pound receptacle) may be larger than the first size and be capable of depositing measurements of ingredients that range from 1 Tbsp-1 Cup. The third size (e.g., a two-pound receptable) may be larger than the second size and be capable of depositing measurements of ingredients that range from 1 Tbsp-1 Cup. The fourth size (e.g., five-pound receptacle) may be larger than the third size and be capable of depositing measurements of ingredients that range from 1 Tbsp-2 cups. While only four sizes are discussed, it will be understood that more or less than four sizes may be manufactured and include other types of measurements, such as liters or ounces. In some embodiments, the various sizes of housings may be configured to be a single unit where all sizes may be removably attachable to each other and the single unit may be installed. The various sizes of the housings may be color coded so as to allow a user to know the size of the housing based on color. For example, the third size may be blue while the fourth size is red. Other indicia may also be used, such as etched weights and measurements on an outer surface of the housing 402.

The insert 404 may comprise a shaft 406 that protrudes from the center thereof. The shaft may be hexagonally shaped and configured to rotate the insert 404 once placed within the housing 402. The insert 404 may be shaped to fit within the housing 402, having a diameter slightly smaller than the inner diameter of the housing 402. The insert 404 may include cavities 408 that receive various measurements of ingredients, whether solids or liquids. One or more support arms 410 may couple to the shaft 406 and aid in rotation of the insert 404. A user may rotate the insert 404 to the desired cavity and then rotate until the ingredients are deposited via the door 403. The cavities 408 may each be configured to receive a predetermined amount of dry or liquid ingredients. For example, one of the cavities 408 may be a size and depth that measures ¼ of a cup of ingredients while a second cavity may be a size and depth that measures ½ of a cup of ingredients. While four cavities are shown, it will be appreciated that more or less than four cavities may be in the insert 404. There may be a plurality of walls that separate and define each of the cavities 408 on the insert 404.

To use the receptacle apparatus 400 and deposit ingredients, a user may dispense the dry or liquid ingredients by turning/rotating the insert 404. In some embodiments, a handle, lid coupled to the shaft 406 may be used, or any other actuator to rotate the insert 404.

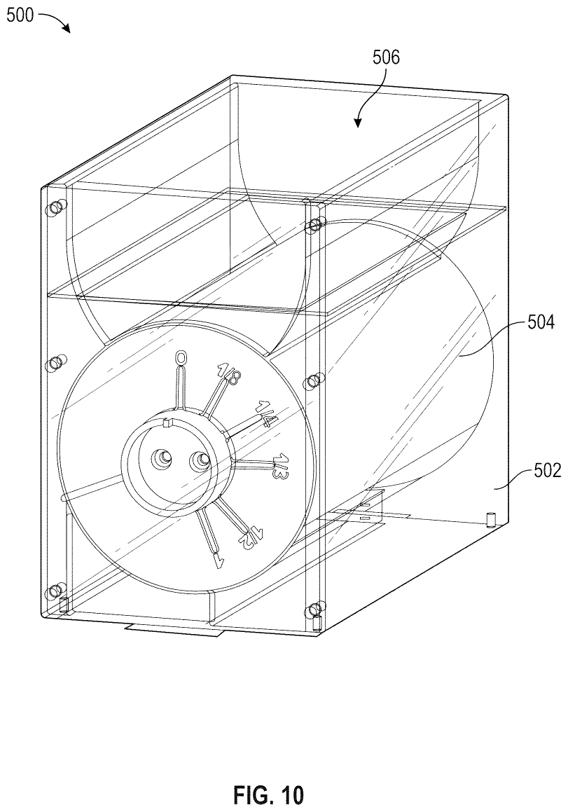

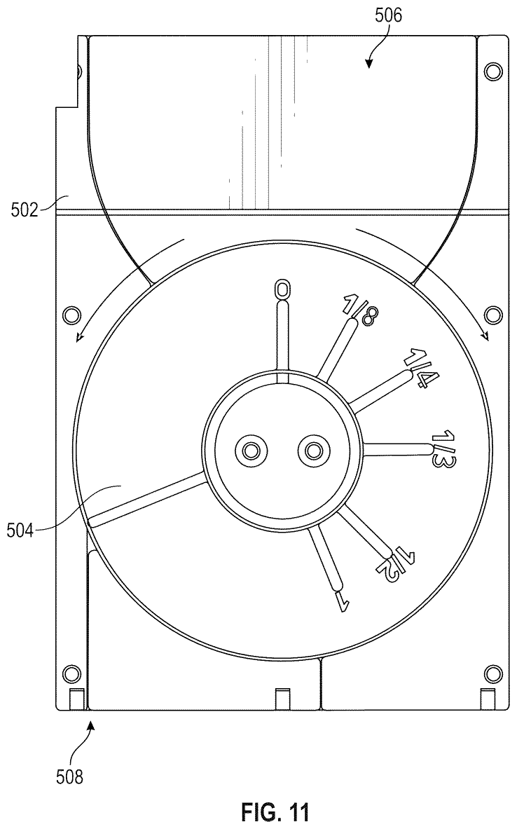

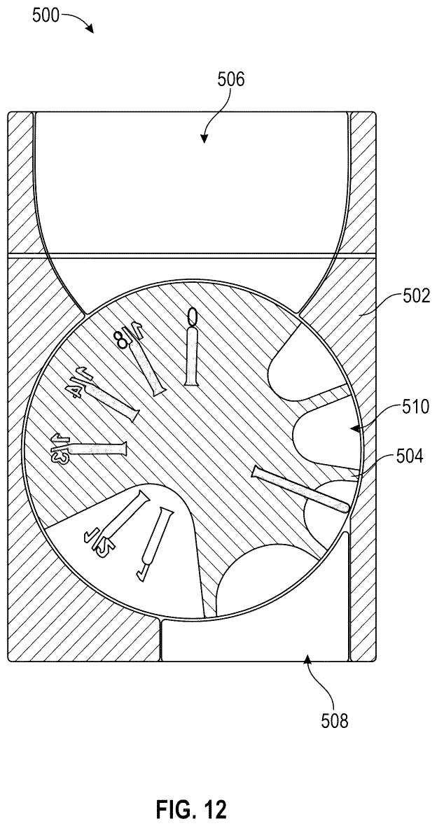

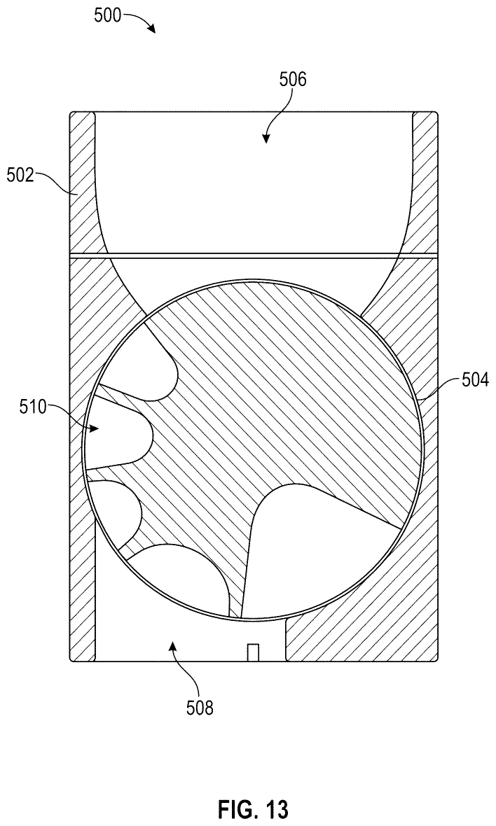

As shown in FIGS. 10-13, in one embodiment, an ingredient storage receptacle apparatus 500 with adjustable measuring and dispensing (hereinafter referred to as the “receptacle apparatus”) comprises a housing 502 and a drum 504 that is rotatably coupled in the housing 502. The housing 502 may be generally square shaped. Other shapes of the housing 502 may include a substantially cylindrical shape or any other shape of housing. The housing 502 may be a wooden material, a food grade plastic (e.g., high-density polyethylene, low-density polyethylene, and/or polypropylene), a metal (e.g., stainless steel and/or aluminum), any combination thereof, or any other food grade material known in the art. The housing 502 may include a trough 506 at the opening thereof where the ingredients may be placed. A lid may also be affixed to an upper portion of the housing 502. A bottom of the housing 502 may include a dispensing aperture 508 where ingredients are dispensed. The housing 502 may vary in construction and configuration based on the ingredients placed therein. For instance, some housings that are configured to receive liquids may be manufactured so as to prevent leaks and ensure longevity of the liquid ingredients. The housing 502 may be manufactured to be numerous sizes in height, length, and width. For example, a first size of the housing 502 may be used for a dry ingredient, such as flour, while a second size, smaller than the first size, may be configured to receive a liquid, such as cooking oil. In some embodiments, there may be a first size, a second size, a third size, and a fourth size of the housing. The first size may receive, for example, spices and be capable of depositing measurements that range from ⅛ tsp-1 Tbsp. The second size (e.g., a one-pound receptacle) may be larger than the first size and be capable of depositing measurements of ingredients that range from 1 Tbsp-1 Cup. The third size (e.g., a two-pound receptable) may be larger than the second size and be capable of depositing measurements of ingredients that range from 1 Tbsp-1 Cup. The fourth size (e.g., five-pound receptacle) may be larger than the third size and be capable of depositing measurements of ingredients that range from 1 Tbsp-2 cups. While only four sizes are discussed, it will be understood that more or less than four sizes may be manufactured and include other types of measurements, such as liters or ounces. In some embodiments, the various sizes of housings may be configured to be a single unit where all sizes may be removably attachable to each other and the single unit may be installed. The various sizes of the housings may be color coded so as to allow a user to know the size of the housing based on color. For example, the third size may be blue while the fourth size is red. Other indicia may also be used, such as etched weights and measurements on an outer surface of the housing 502.

The drum 504 may comprise troughs 510 that receive various measurements of ingredients, whether solids or liquids. A user may rotate the drum 504 to the desired trough 510 and then rotate until the ingredients are deposited via the dispensing aperture 508. The troughs 510 may each be configured to receive a predetermined amount of dry or liquid ingredients. For example, one of the troughs 510 may be a size and depth that measures ¼ of a cup of ingredients while a second trough may be a size and depth that measures ½ of a cup of ingredients. While five troughs are shown, it will be appreciated that more or less than five troughs may be in the drum 504. There may be a plurality of walls that separate and define each of the troughs 510 on the drum 504. To use the receptacle apparatus 500 and deposit ingredients, a user may dispense the dry or liquid ingredients by turning the drum 504.

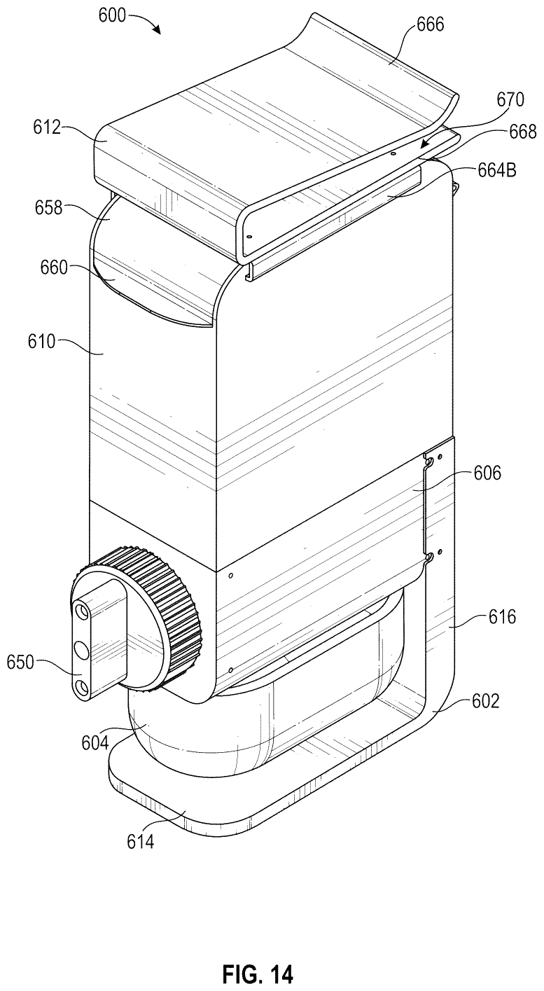

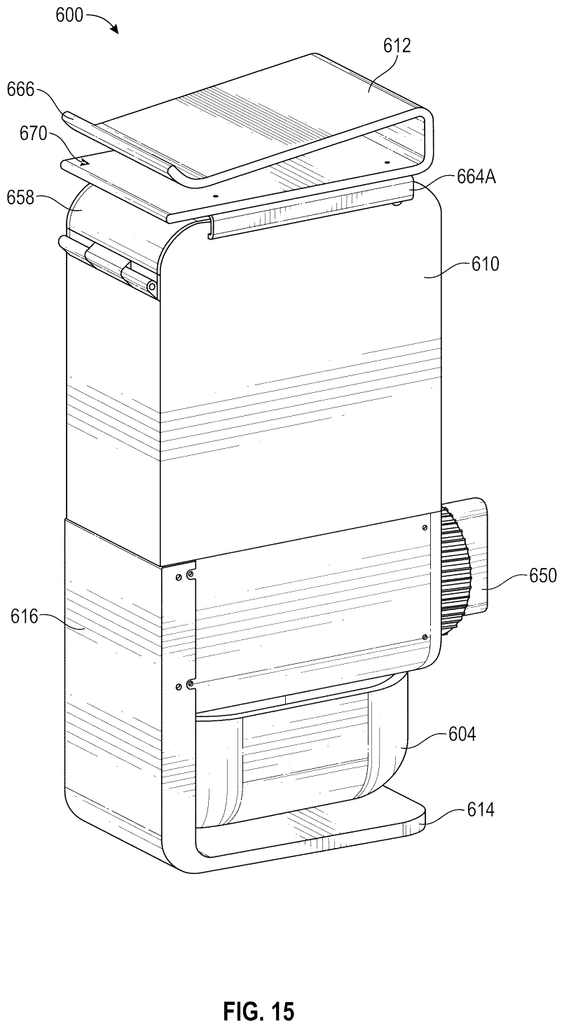

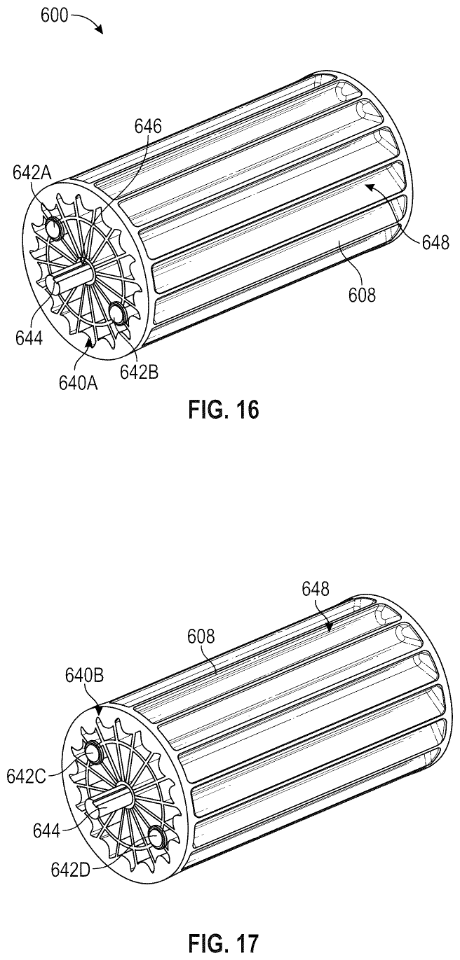

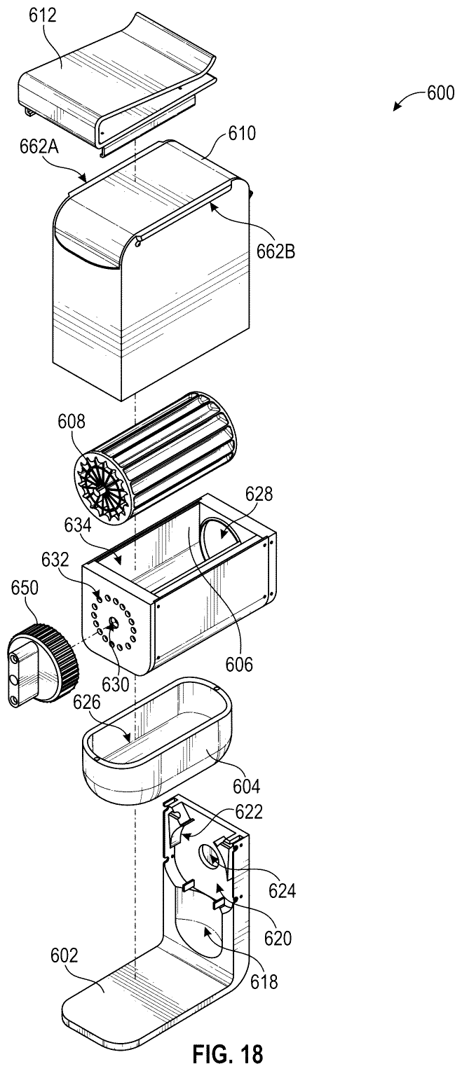

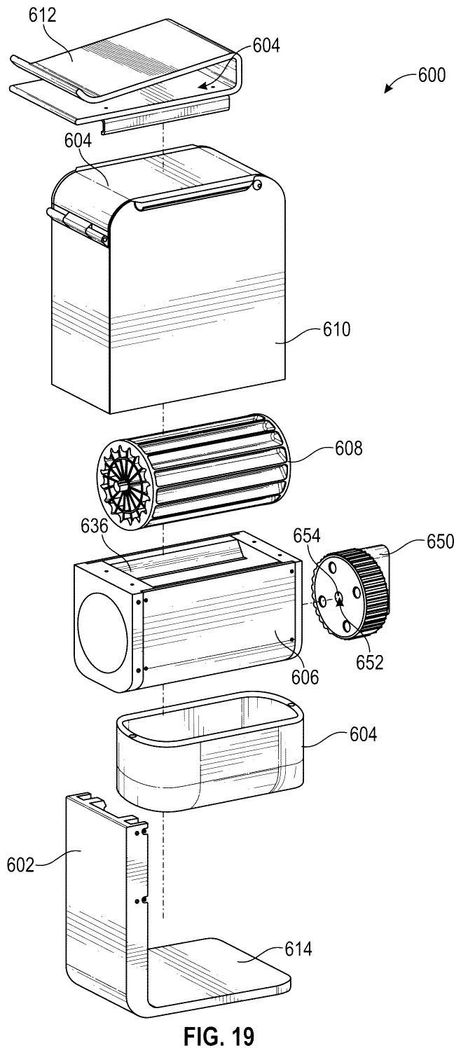

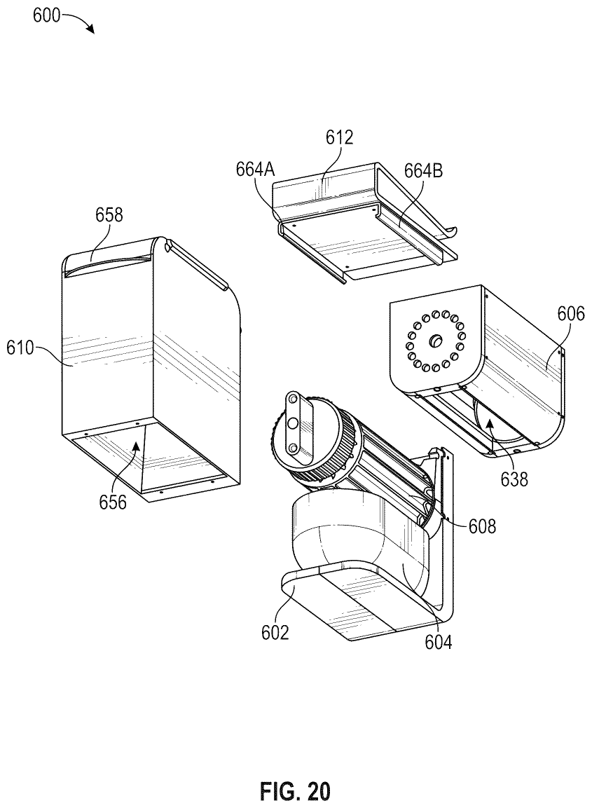

As shown in FIGS. 14-20, in one embodiment, an ingredient storage receptacle apparatus with adjustable measuring and dispensing 600 (hereinafter referred to as the “apparatus”) comprises a stand 602, a container 604, a housing 606, a roller 608 positionable in the housing 606, a hopper 610, and a clip 612 removably attachable to the hopper 610.

The stand 602 may include a first portion 614 and a second portion 616, with the first and second portions 614, 616 being at generally a 90-degree angle in relation to each other. On the second portion 616 of the stand 602, the stand 602 may include a depression 618 that receives an end of the container 604. The depression 618 may match the shape of the container 604 end. The second portion 616 may also include a roller portion 620 that includes protrusions 622 and a hole 624, all of which are configured to receive and help stabilize the roller 608. The stand 602 may be configured to be placed on a counter or a shelf, as well as provide support to the apparatus 600.

The container 604 may be coupleable to or simply placed and rested on the first portion 614 of the stand 602. The container 604 may include a storage area 626 where solid or liquids are deposited from the apparatus 600. The container 604 can be removed once the ingredients (e.g., flour, sugar, salt, baking powder, baking soda) are deposited so that these materials can be transported to another container, if desired, to mix ingredients. The container 604 may vary in both size and shape. For example, in some embodiments, the container 604 may have rounded edges and be able to receive numerous cups of flour. In some embodiments, the size of the container 604 may vary based on the ingredients within the apparatus 600 and the size of the apparatus itself. In some embodiments, a user may use their own container to retrieve the solids or liquids.

The housing 606 may be positioned above the container 604 and coupled to the second portion 616 of the stand 602. The housing may be substantially rectangular in shape. The housing 606 may be configured to receive the roller 608. The housing 606 may include a rear aperture 628 to receive an end of the roller 608. An end opposite the rear aperture 628, may include a center aperture 630 to receive a portion of the roller 608. The center aperture 630 may be surrounded by a plurality of first apertures 632 that are in a substantially circular pattern. The housing 606 may include an inner compartment 634 where the roller 608 is placed. On an inner side of the housing 606, there may be a scraping member 636 the descends from a top edge of the housing 606 at a first angle and then turns upward at a second angle. The scraping member 636 is configured to remove excess materials from the roller 608 and being deposited into the container 604. The scraping member 636 may be or include brushes, rubber, etc. to assist in scraping ingredients. Furthermore, the inner compartment 634 may also include brushers, rubber, etc. to assist in leveling ingredients. The bottom of the housing 606 may include a housing aperture 638 where ingredients can exit the housing 606 and be deposited into the container 604. The housing aperture 638 may be from one end to the other on the bottom of the housing 606. In some embodiments, the housing aperture 638 may be a slit and/or may extend a portion of the bottom of the housing 606.

The roller 608 may be cylindrically shaped. The roller 608 may have a first roller end 640A and a second roller end 640B. The first end 640A may include a first spring plunger 642A and a second spring plunger 642B. The second end 640B may include a third spring plunger 642C and a fourth spring plunger 642D. The first, second, third, and fourth spring plungers 642A-642D may be ball nose spring plungers. The first, second, third, and fourth spring plungers 642A-642D may be configured to adjust and secure the roller 608 into various positions. That is, as a user rotates the roller 608, the first and second spring plungers 642A, 642B interact with or protrude into the plurality of first apertures 632, thereby allowing the roller 608 to be systematically rotated and secured via the first and second spring plungers 642A, 642B. Likewise, the third spring plunger 642C and the fourth spring plunger 642D may assist the roller 608 in being systematically rotated, adjusted, and secured. While four spring plungers 642A-642D are shown, it will be appreciated that more or less than four may be used. Furthermore, while spring plungers are shown, it will be understood that other mechanisms may be used without departing herefrom. The roller 608 may have a shaft 644 that passes through the roller 608 from the first end 640A to the second end 640B, extending from both ends 640A, 640B. The shaft 644 may include a notch 646 that may travel from one end of the shaft 644 to the other. The shaft 644 at the first end 640A of the roller 608 may be positioned within and through the center aperture 630, and the shaft 644 at the second end 640B may pass through the rear aperture 628 to the hole 624 in the second portion 616 of the stand 602. The roller 608 may include a plurality of troughs 648, or, in some embodiments, one or more troughs, that circumscribe an outer surface thereof and extend from the first end 640A to the second end 640B. The plurality of troughs 648 may be the same size, different sizes, or some combination thereof. In some embodiments, the troughs 648 may be configured to be a measurement size, meaning a trough may be a teaspoon, tablespoon, any cup size, quarts, etc. It will be appreciated that a user would then be able to move the roller 608 to the correct trough and deposit the correct measurement of ingredients. The shaft 644 that protrudes from the center aperture 630 may receive a dial knob 650 that includes a plurality of teeth and a protrusion where a user can grab. A rear side of the dial knob 650 may include a dial aperture 652 with a ridge 654, the ridge 654 being positioned in the notch 646 on the shaft 644. In some embodiments, the outer surface of the housing 606, the side with the plurality of apertures 632, and/or the dial 650 may include measurement markings. The measurement marks/indicia may correlate with a particular trough size, so, for example, if a user desired a quarter cup of ingredients, the user could rotate the dial knob 650 to the correct measurement mark that correlates with the quarter cup trough so as to deposit that amount. It will be appreciated that the apparatus 600 allows a user to quickly rotate the roller 608 to the correct measurement so as to deposit the ingredient into the container 604. As discussed above, the scraping member 636 may remove excess ingredients from the trough, thereby allowing a precise measurement in each trough 648.

Positioned above and coupleable to an upper surface of the housing 606 may be the hopper 610. The hopper 610 may be generally rectangular in shape and configured to receive and store an ingredient. A bottom of the hopper 610 may include a lower hopper aperture 656, where ingredients can exit the hopper 610 and rest on and in the troughs 648 of the roller 608. A top of the hopper 610 may include a hingedly coupled lid 658 with a lip 660. The user may grab the lip 660 and open the lid 658 so as to gain access to and deposit ingredients into the interior compartment of the hopper 610. In some embodiments, the lid 658 may be placed on the top of the hopper 610 without being connected, it may be threaded onto the top of the hopper 610, or attached and actuated in any other manner known in the art. Furthermore, a top, first side may include a first groove 662A and a top, second side may include a second groove 662B.

The top of the hopper 610 may receive a removably attachable clip 612. The clip 612 may have a first finger 664A on first side of the lower surface and a second finger 664B on a second side of the lower surface. The first and second fingers 664A, 664B may be removably attachable to the first and second grooves 662A, 662B. The clip 612 may include a first panel 666 coupled and parallel to a second panel 668, with a gap 670 interposed between the first and second panels 666, 668. Accordingly, a user can slide the clip 612 onto a shelf, for example, with the shelf being positioned in the gap 670 and between the first and second panels 666, 668. The clip 612 can be used if the user desires to have the stand 602 in the air and not flat on a surface.

It will be understood that while various embodiments have been disclosed herein, other embodiments are contemplated. Further, certain embodiments of the present disclosure may include, incorporate, or otherwise comprise properties or features described in other embodiments. Consequently, various features of certain embodiments can be compatible with, combined with, included in, and/or incorporated into other embodiments of the present disclosure. Therefore, disclosure of certain features or components relative to a specific embodiment of the present disclosure should not be construed as limiting the application or inclusion of said features or components to the specific embodiment unless stated. As such, other embodiments can also include said features, components, members, elements, parts, and/or portions without necessarily departing from the scope of the present disclosure. The embodiments described herein are examples of the present disclosure. Accordingly, unless a feature or component is described as requiring another feature or component in combination therewith, any feature herein may be combined with any other feature of a same or different embodiment disclosed herein. Although only a few of the example embodiments have been described in detail herein, those skilled in the art will appreciate that modifications are possible without materially departing from the present disclosure described herein. Accordingly, all modifications may be included within the scope of this invention.

What is claimed is:

1. An ingredient storage receptacle apparatus with adjustable measuring and dispensing, the apparatus comprising:
a stand;
a housing coupleable to the stand;
a roller positionable in an inner compartment of the housing; and
a hopper coupleable to an upper portion of the housing, the hopper comprising a lid and a lower hopper aperture.

2. The apparatus of claim 1, wherein the stand comprises a first portion and a second portion, the first portion being substantially at a 90-degree angle to the second portion.

3. The apparatus of claim 2, wherein the second portion comprises a depression that receives an end of a container.

4. The apparatus of claim 2, wherein the second portion comprises a roller portion that includes one or more protrusions and a hole that receives an end of the roller.

5. The apparatus of claim 1, wherein the lid is hingedly coupled to the hopper.

6. The apparatus of claim 1, wherein the lid comprises a lip.

7. The apparatus of claim 1, further comprising a container that is positionable on and removably attachable to the stand.

8. The apparatus of claim 1, wherein the housing is coupled to a second portion of the stand.

9. The apparatus of claim 1, wherein the housing comprises a rear aperture to receive an end of the roller.

10. The apparatus of claim 1, wherein the housing comprises a center aperture and a plurality of first apertures that surround the center aperture.

11. The apparatus of claim 1, wherein the inner compartment of the housing comprises a scraping member.

12. The apparatus of claim 1, wherein a bottom of the housing comprises a housing aperture where ingredients are deposited.

13. The apparatus of claim 1, wherein the roller comprises one or more troughs.

14. An ingredient storage receptacle apparatus with adjustable measuring and dispensing, the apparatus comprising:
a stand with a first portion and a second portion;
a housing coupleable to the stand;
a roller positionable in an inner compartment of the housing, the roller comprising one or more troughs;
a hopper coupleable to an upper portion of the housing, the hopper comprising a lid and a lower hopper aperture; and
a container that is positioned on the first portion of the stand and underneath the housing.

15. The apparatus of claim 14, wherein the inner compartment of the housing comprises a scraping member.

16. The apparatus of claim 14, wherein a bottom of the housing comprises a housing aperture where ingredients are deposited.

17. The apparatus of claim 14, wherein the lid is hingedly coupled to the hopper.

18. The apparatus of claim 14, wherein the roller comprises a shaft that passes from a first end to a second end.

19. The apparatus of claim 14, wherein the roller comprises one or more spring plungers that interact and are inserted into a plurality of first apertures on an end of the housing.

20. An ingredient storage receptacle apparatus with adjustable measuring and dispensing, the apparatus comprising:
a stand with a first portion and a second portion;
a housing coupleable to the stand;
a roller positionable in an inner compartment of the housing, the roller comprising a plurality of troughs, a shaft that passes through the roller and protrudes through both ends of the housing to the second portion of the stand and through the housing, a dial knob coupleable to the shaft protruding from the housing, and one or more spring plungers;
a hopper coupleable to an upper portion of the housing, the hopper comprising a lid and a lower hopper aperture;
a container that is positioned on the first portion of the stand and underneath the housing;
wherein the plurality of troughs measure and deposit a certain, pre-determined amount of ingredients.
